(19) United States
(12) Patent Application Publication
(10) Pub. No.: US 2010/0175058 A1
(43) Pub. Date: Jul. 8, 2010

(54) SYSTEM FOR PROVIDING DISTRACTION-FREE CONTENT IN A FLASH-BASED GAMING ENVIRONMENT

(76) Inventors: Andrew A. Radin, San Jose, CA (US); Jeffrey Sawatzky, Montreal (CA)

Correspondence Address: FOLEY & LARDNER LLP, 150 EAST GILMAN STREET, P.O. BOX 1497, MADISON, WI, 53701-1497, US

(21) Appl. No.: 12/546,075

(22) Filed: Aug. 24, 2009

Related U.S. Application Data
(63) Continuation-in-part of application No. 12/471,582, filed on May 26, 2009.
Application No. 12/471,582 is a continuation-in-part of application No. 12/349,050, filed on Jan. 6, 2009.

(51) Int. Cl. G06F 9/44

(52) U.S. Cl. 717/168; 717/110

(57) ABSTRACT

A method and tool for providing distraction-free content in a software program is presented. The method includes accessing an executable software file containing software code that upon execution carries out a software program and modifying the executable software file with a service insertion tool. The modified executable software file causes the software program to present a visual display of the software program in a full-screen mode and present additional content in the visual display of the software program in response to pre-defined triggers. The service insertion tool includes a viewer for presenting the software program in a user interface and for receiving user inputs via the user interface, and a processor for modifying the executable software file.

### CROSS REFERENCE TO RELATED APPLICATIONS

This application is a continuation-in-part of U.S. patent application Ser. No. 12/471,582, filed May 26, 2009, and entitled “ASSOCIATING ADVERTISEMENTS AND GAME DATA IN A FLASH-BASED GAMING ENVIRONMENT,” which in turn is a continuation-in-part of U.S. patent application Ser. No. 12/349,050, filed Jan. 6, 2009, and entitled “ASSOCIATING ADVERTISEMENTS AND GAME DATA IN A FLASH-BASED GAMING ENVIRONMENT.” U.S. patent application Ser. Nos. 12/471,582 and 12/349,050 are herein incorporated by reference.

### FIELD

The subject of the disclosure relates generally to modification of Flash-based computer software. More specifically, the disclosure relates to a system that provides a distraction-free advertising experience with a Flash-based computer game or other Flash-based application.

### SUMMARY

The Adobe Flash player provides a widely available graphical run-time computing environment. It runs on devices ranging from cellular phones to personal computers and is compatible with most operating systems commonly found on such devices. Although originally developed as an environment for producing computer animation sequences and movies, this ubiquitous support has also made it a popular choice as a programming and run-time environment for delivering online video games to consumers.

The executable game format delivered from game developers to game publishers and distributors is Adobe's proprietary Flash SWF (Shockwave Flash) file format. This file consists of binary bytecode instructions and data that is interpreted at runtime by the Flash player application to render the interactive game.

Game publishers and distributors seek to maximize revenue generated from games with a variety of business models including advertising-driven revenue. They may also wish to create a social environment around online Flash games that allows players to compete head to head, compare scores, issue challenges and track their competitor's progress. U.S. patent application Ser. Nos. 12/471,582 and 12/349,050 provide methods and systems for modifying Flash programs in order to insert various content such as advertisements. As such, advertisements may be rendered within the context of a Flash program.

Flash programs are typically provided within a web browser. Modern multi-tasking operating systems present these browsers within windows on a desktop. This allows the user to simultaneously access and view Flash programs as well as alternative computer programs. As such, there is nothing to prevent the user from avoiding the advertisement completely by clicking on another application or window. In addition, existing flash-based game advertising solutions provide advertisements on only a portion of the computer screen. The computer may present a variety of other data and information on the screen alongside the advertisement. This additional data and information competes for the attention of the user.

Advertisements that provide a higher probability of being viewed by a user will generate higher revenues. Accordingly, described herein is a system and method by which a Flash-based or other computer application may be modified so that it is displayed in a full-screen mode along with its associated advertisements and other forms of media content. When in full-screen mode, all other computer functions and windows are hidden from the user. When these functions and windows are hidden from the user, the user's attention is focused exclusively on the game play, advertisements, and associated media content. In addition, if a user exits the full-screen mode, the user is prevented from continuing game play until the full-screen mode has been re-entered. As such, a distraction-free environment for displaying and viewing the advertisements and associated media content may be achieved and advertising revenues may be further optimized.

A representative embodiment includes a method for providing distraction-free content in a gaming environment. The method can include accessing an executable software file containing software code that upon execution carries out a software program and modifying the executable software file with a service insertion tool. The modified executable software file causes the software program to present a visual display of the software program in a full-screen mode and to present additional content in the visual display of the software program in response to pre-defined triggers.

In a second representative embodiment, a service insertion tool includes a viewer and a processor. The viewer presents a software program in a user interface and receives user inputs via the user interface. The processor is configured to modify an executable software file of the software program, such that the software program presents a visual display of the software program in a full-screen mode and presents additional content in the visual display of the software program in response to pre-defined triggers.

A third representative embodiment includes a method for providing distraction-free advertisements in a Flash-based gaming environment. The method includes modifying a Flash-based software program using a service insertion tool. The modified Flash-based software program presents a visual depiction of the software program on a distraction-free display and presents advertisements in the visual depiction of the software program in the distraction-free display.

Other principal features and advantages will become apparent to those skilled in the art upon review of the following drawings, the detailed description, and the appended claims.

### BRIEF DESCRIPTION OF THE DRAWINGS

Representative embodiments are hereafter described with reference to the accompanying drawings.

FIG. 1 is a flow diagram illustrating operations performed by a distraction-free content delivery system in accordance with a representative embodiment.

FIG. 2 is a block diagram illustrating a service insertion tool in accordance with a representative embodiment.

FIG. 3 is a flow diagram illustrating operations performed by a modified Flash-based game in accordance with a representative embodiment.

FIG. 4 is a graphical user interface (GUI) of a Flash application prior to entry into a full-screen mode in accordance with a representative embodiment.

FIG. 5 is a GUI of a Flash application in a full-screen mode in accordance with a representative embodiment.

FIG. 6 is a GUI of a Flash application after exiting a full-screen mode in accordance with a representative embodiment.

### DETAILED DESCRIPTION

The Adobe Flash system includes a visual development environment that saves and works with Flash programs in their “source code” format, which is a proprietary binary-formatted Flash source file (FLA) file. When a Flash movie or game is distributed to end users, the Flash development environment “publishes” the service into an executable form. This executable form of Flash service is a proprietary binary-formatted SWF file containing bytecode instructions and data that completely specify the execution of the service. The Flash player is the run-time environment that is responsible for interpreting and executing the bytecode and data in the SWF file.

SWF files contain a series of tags that describe the visual elements and sounds used in the game, along with their movements and transformations. In addition to these tags, the developer of the game can include logic written in the ActionScript scripting language. During the publishing process, this ActionScript logic is transformed from its textual representation to a bytecode representation in the SWF file. While not a completely reversible process, it is possible however to re-interpret this bytecode representation such that the original ActionScript that produced it is approximated sufficiently to allow its modification using a service or advertisement insertion tool.

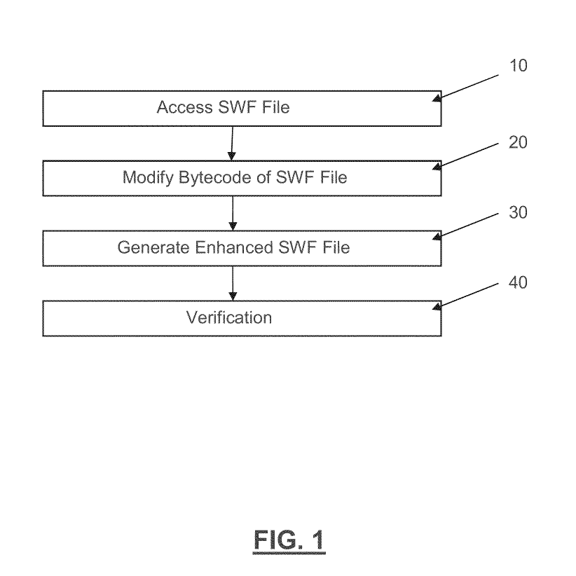

FIG. 1 is a flow diagram illustrating operations performed by a distraction-free content delivery system in accordance with a representative embodiment. Additional, fewer, or different operations may be performed in alternative embodiments. In a representative embodiment, the delivery system allows for the insertion of a service that causes a distraction-free presentation of content such as advertisements within a Flash program or other computer program. The inserted service causes the output of the Flash program to be presented in a full-screen mode, wherein the output of the Flash program covers at least a substantial portion of a display screen such that other functions and windows of the desktop on which the Flash program is displayed are not easily visible to the user. In a representative embodiment, the entire display screen is covered by the Flash program display when in full-screen mode. In an alternative embodiment, the inserted service may cause a presentation of other content such as a survey or information regarding rival players or may cause an extraction of player achievement data. In an operation 10, a service insertion tool accesses a SWF program file such as a SWF file for a game. In an operation 20, the service insertion tool modifies the bytecode and associated instructions of the SWF game file such that specialized libraries are injected into the Flash program. In an embodiment, the service insertion tool may modify various functions of the SWF game file which may include logic designated to cause the execution of various tasks by the Flash program. In another embodiment, the bytecode of the various functions are modified to include additional logic that when executed cause a selected advertisement or other content to be presented in response to an occurrence of a designated advertisement trigger. At the conclusion of the advertisement, a handler function executes its original bytecode logic so that the game is resumed again at the appropriate point after termination of the advertisement. Additional embodiments and details for modifying the SWF game file can be found in U.S. patent application Ser. Nos. 12/471,582 and 12/349,050, which have been incorporated by reference.

In an operation 30, the original SWF game file is transformed into a new enhanced SWF game file. As such, the modified bytecode associated with the original SWF game file is inserted into a new enhanced SWF game file along with the remaining unchanged portions of the original SWF game file. In an operation 40, the service insertion tool plays the game again allowing the technician to verify that the advertisement or other content is triggered and displayed as expected and that the game otherwise functions properly.

Later, when the game is played by a game player, the game player will be presented with a request to enter into full screen mode. Upon receiving the appropriate input from the game player, the game enters a distraction-free full-screen mode. Various content, such as advertisements or other media content, may be presented in response to an occurrence of the selected content triggers based on an established service policy. A service policy may be downloaded at the start of the game from a service policy server or may be alternatively communicated to the enhanced game SWF file. The service policy contains instructions as to what content is presented, when the content is presented, and how the content is presented.

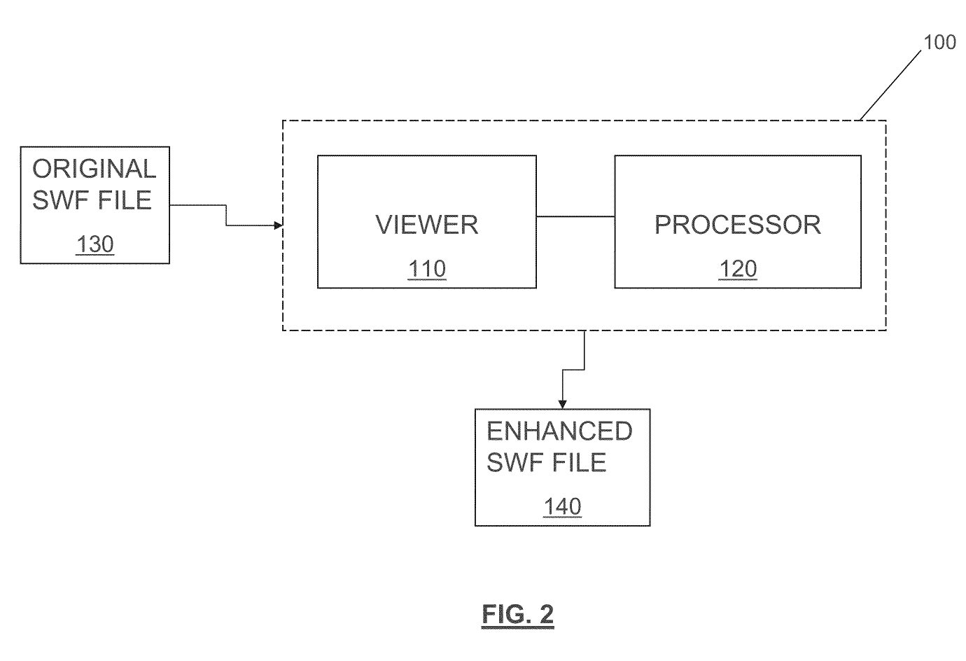

FIG. 2 is a block diagram illustrating a service insertion tool 100 in accordance with a representative embodiment. Service insertion tool 100 includes a GUI-based viewer 110 and a processor 120. Service insertion tool 100 may be a server, a personal computer, or a similar computing device having a processor capable of modifying an SWF file. An original SWF file 130 is accessed via service insertion tool 100. Original SWF file 130 includes all logic necessary to execute the corresponding Flash program or game. Viewer 110 displays the running Flash program and presents a user interface that allows a technician to interact with the program. Viewer 110 is further configured to receive inputs from the technician. Processor 120 is programmed to analyze the bytecode instructions contained in original SWF file 130, process inputs received from the technician, and implement modifications to the original SWF file 130 to cause various libraries to be injected into the Flash program and content such as advertisements to be presented during execution of the Flash program. Processor 120 implements modifications by inserting pre-defined blocks of logic that handle initialization of data structures and execution of a service that causes various content to be presented upon execution of the Flash program. Service insertion tool 100 produces an enhanced SWF file 140. Enhanced SWF file 140 includes the logic modified to insert a service that causes content and advertisements to be presented and any original logic that was unmodified during the service insertion process. It should be apparent to those of skill in the art, that alternative methods and tools may be utilized for modifying the SWF files of Flash programs as well as executable files of other non-Flash programs.

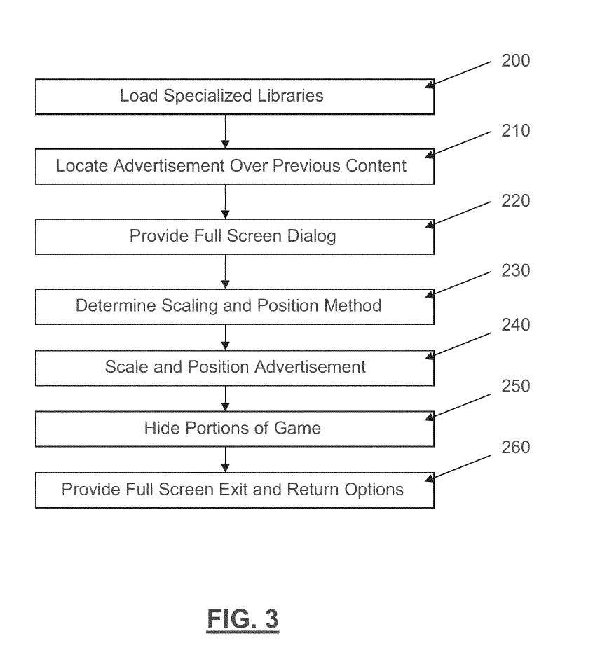

FIG. 3 is a flow diagram illustrating operations performed by the modified Flash-based game in accordance with a representative embodiment. Additional, fewer, or different operations may be performed depending on the particular implementation. In addition, the operations may be performed in any suitable order other than that presented below. Also note that a “Flash-based game” is referenced throughout the following discussion. It should be apparent to one of skill in the art, that the following operations can be performed in association with any type of Flash-based application or other computer program. In an operation 200, a Flash-based game that has been modified, as described in accordance with FIGS. 1 and 2 above, loads a set of libraries from a remote server. These injected libraries include instructions and functionality to allow the modified Flash-based game to enter a full-screen mode. Full-screen mode was added in Flash version 9. Prior versions of Flash did not include a full-screen mode. In a representative embodiment, the injected libraries include instructions and functionality by which these prior versions of Flash may incorporate a full-screen mode. The injected libraries also allow advertisements to be presented at appropriate places within the modified Flash-based game.

In an operation 210, the modified Flash-based game ensures that any inserted advertisements are presented over the pre-existing game content. In a first representative embodiment, the modified Flash-based game uses an ActionScript version 1 or an ActionScript version 2 programming language to control the behavior of the game. ActionScript versions 1 and 2 use “levels” to define how content is presented. For example, content belonging to a higher level will be presented over content belonging to a lower level. Newly presented content belonging to a same level as old content is displayed over the old content. According to the first representative embodiment, the modified Flash-based game loads content from the injected libraries into a higher level than any of the Flash-based game's pre-existing levels. In this way, the content from the injected libraries is presented over the original content of the game.

In an alternative embodiment, where the modified Flash-based game utilizes an ActionScript version 3 programming language, there are no levels. The ActionScript version 3 programming language includes a notification when new content is added to a stage of the game. This notification is known as an “event.” The injected libraries instruct the modified Flash-based game to send an event to the injected libraries whenever the game adds new content to the stage. When the libraries receive an event, the injected libraries cause the game to remove any advertising or other associated media content from the stage and then re-add it into the stage. When the advertising or associated media content is re-added to the stage, it is presented over all the pre-existing content of the game.

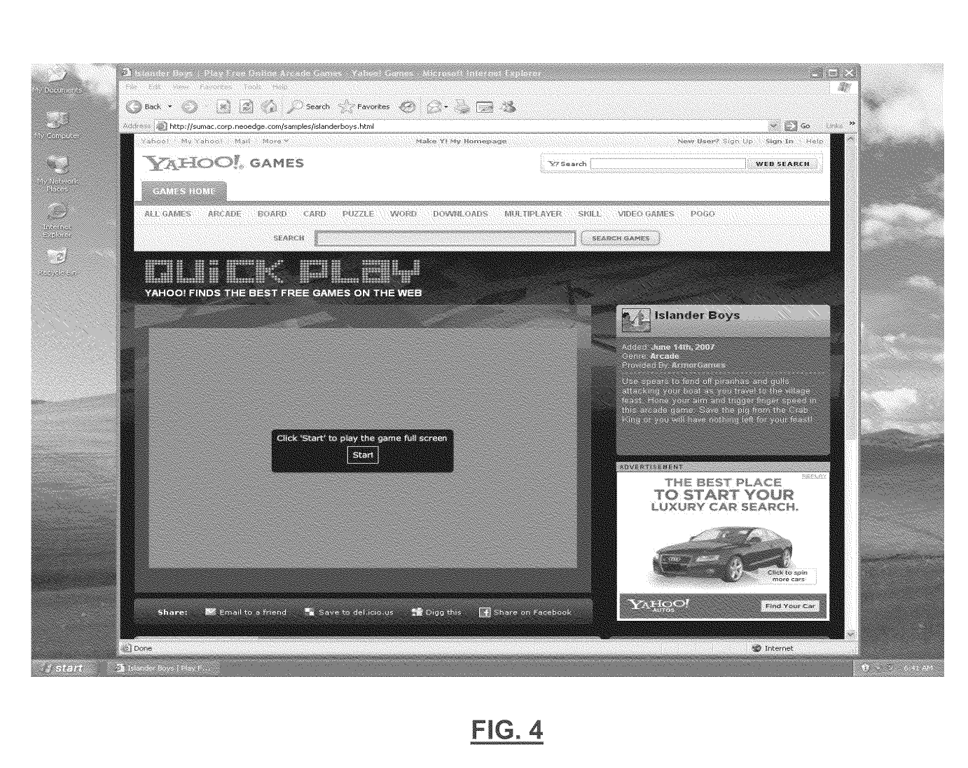

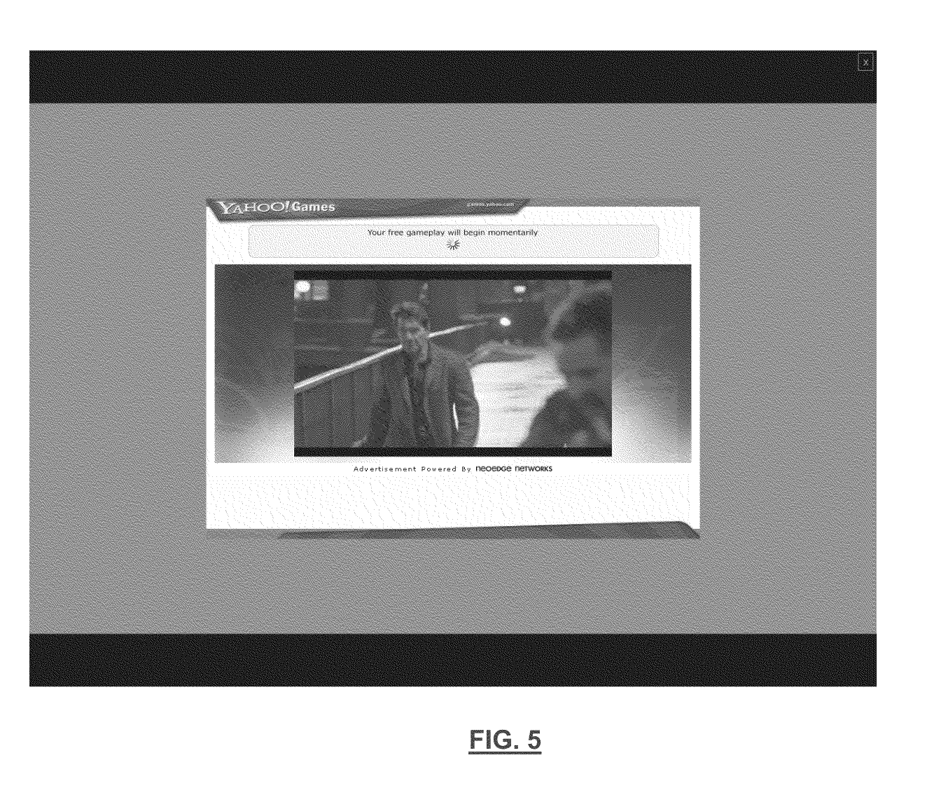

In an operation 220, the injected libraries cause the modified Flash-based game to present a dialog and input box to the user that requests the user to provide an input to cause the game to enter a full-screen mode. Once the user provides the appropriate input, the Flash-based game enters the full-screen mode. FIG. 4 depicts a graphical user interface (GUI) of a Flash-based game prior to entry into a full-screen mode in accordance with a representative embodiment. Once in the full-screen mode, the Flash-based game covers a substantial portion of the display screen on which the Flash-based game is being presented to the user. In a representative embodiment, the Flash-based game covers the entire display screen when in the full-screen mode. FIG. 5 depicts a GUI of a Flash-based game in a full-screen mode in accordance with a representative embodiment.

In an operation 230, the scaling and position methods utilized by the Flash-based game are determined. The injected libraries cause the application programming interface to retrieve these scaling and position methods from the Flash-based game. The scaling and position methods may be specified by the HTML of the web page presenting the Flash-based game or may be set within the program language of the Flash-based game itself. The scaling and position methods affect how and where on the display screen the game is shown.

In an example, a game may have content that is off-screen and not visible to the user when a game is played in a normal screen mode. An example of such a game may be a side scrolling game such as Super Mario Brothers, wherein content is included off the screen to both the left and the right. Typically, this off screen content is not displayed until the user moves the game character to the edge of the screen, wherein the game responds by scrolling to the left or to the right to reveal the off screen content. However, when the game is presented in a full-screen mode, a portion of this previously off-screen content may now be displayed on the display screen. As such, the scaling and position methods are determined in order to rectify this potential problem.

In an embodiment, several different scaling methods may be utilized by the Flash-based game to scale the displayed content of the game to the display screen. A first scaling method is “show all.” Using the show all method, the game is scaled along the x and y axis proportionately and the game is scaled so that it is as big as possible without extending outside the visible area of the screen. When a game that utilizes such a scaling method is expanded to a full-screen mode, content that would normally be off-screen during a normal screen mode may be visible to the user during a full-screen mode. A second scaling method is “no border.” Using a no border method, the game is scaled along the x and y axis proportionately and the game is scaled so that the whole screen is used. When a game that utilizes a no border scaling method is expanded to a full-screen mode, it is possible that part of the game may be cropped and become invisible to the user.

A third scaling method is “exact fit.” Using the exact fit method, the game is scaled along the x and y axis disproportionately so that the whole screen is used. When a game that utilizes such an exact fit method is expanded to a full-screen mode, the game may be stretched more in one direction than another, resulting in a disfigured image. A fourth scaling method is “no scale.” Using a no scale method, the game is not scaled and instead is shown at normal size. When a game that utilizes a no scale method is expanded to a full-screen mode, content that would normally be off-screen during a normal screen mode may be visible to the user during a full-screen mode.

In an embodiment, several different positioning methods may be utilized by the Flash-based game to position the displayed content of the game within the display screen. Example, positioning methods may include “top left,” “top center,” “top right,” “middle left,” “middle center,” “middle right,” “bottom left,” “bottom center,” and “bottom right.” In an embodiment, when the middle left positioning method is used, the left side of the game is lined up with the left side of the screen and the game is positioned in the middle of the screen vertically. As such, content that would normally be off-screen to the right of the game may not be visible on the right side of the display screen. When the middle center positioning method is used, the game is centered both horizontally and vertically. As such, content that would normally be off-screen to the left or right of the game may not be visible on the right side of the display screen. When the middle right positioning method is used, the right side of the game is lined up with the right side of the screen and the game is positioned vertically in the middle of the screen. As such, content that would normally be off-screen to the left of the game may not be visible on the left side of the display screen. The remaining positioning methods may include similar positioning (i.e., top right is positioned horizontally at the right of the screen and vertically at the top of the screen, bottom left is positioned horizontally at the left of the screen and vertically at the bottom of the screen, and so on).

In an operation 240, the advertisements inserted into the modified Flash-based game are scaled and positioned. Because the advertisements have been inserted into the game and the game has been scaled to a full-screen mode, the advertisements may also have been scaled. Due to this unintended scaling, the advertisements may not be shown as the advertiser originally intended. In addition, scaled advertisements may no longer fit on the display screen or may be disfigured. To rectify this potential problem, the injected libraries use the scaling and positioning methods of the Flash-based game, which were determined in operation 230, to reverse the scaling of the advertisements in the full-screen mode. As such, the advertisements will be displayed in their normal size within the full-screen mode of the Flash-based game. In addition, the positions of the advertisements are adjusted to ensure the advertisement is displayed in the appropriate part of the screen.

In an operation 250, portions of the game that are not normally visible in a normal screen mode but would now be visible because of the full-screen mode are hidden. As described above, when the game is scaled and positioned into full screen mode, portions of the game that are not normally visible may become visible to the user. Using the determined scaling and positioned methods from operation 250, the injected libraries determine what regions of the screen during full-screen mode would normally be off-screen during a normal screen mode. The injected libraries then cause black or other obscuring borders to be drawn over the game content such that the normally off-screen game content is no longer visible to the user.

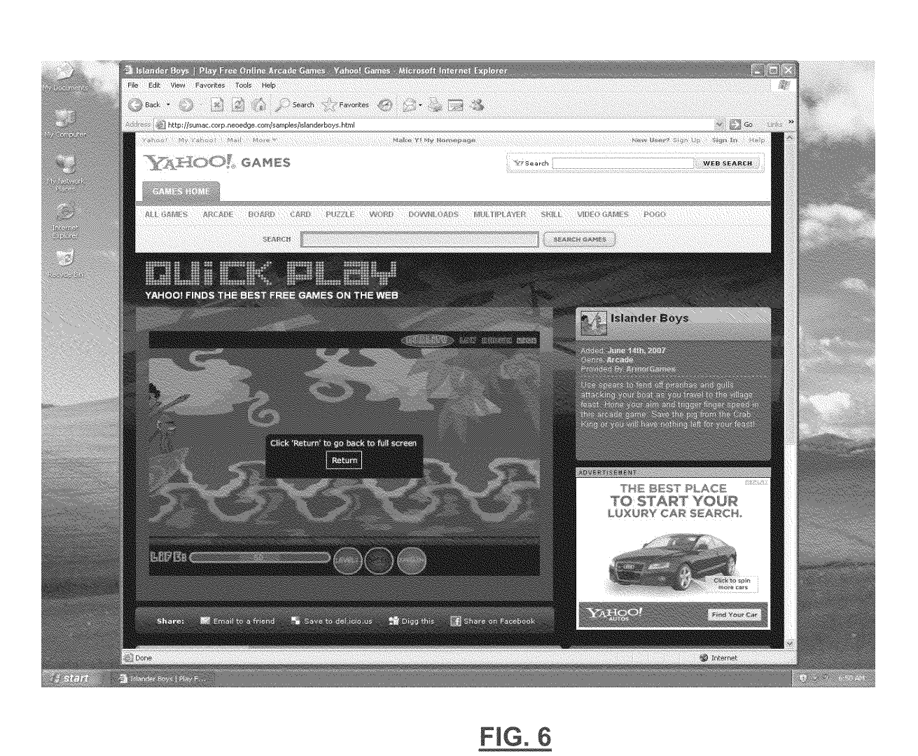

In an operation 260, the injected libraries may cause an exit full screen option to be presented in the full screen display. In an embodiment, the exit full screen option may be a close “X” button in a corner of the display screen. In alternative embodiments, the exit full screen option may be any suitable dialog or button for exiting the full-screen mode. When the exit full screen option is selected by a user and the input is received by the injected libraries, the full-screen mode is exited and the normal screen mode is presented to the user. In an embodiment, in order to continue playing the game, the user must return to the full-screen mode. As such, upon exiting the full-screen mode, the injected libraries prevent the game from being played and present a return to full screen dialog and/or option to the user. FIG. 6 depicts a GUI of a Flash-based game after exiting a full-screen mode in accordance with a representative embodiment. Upon receiving a return to full screen input from the user, the injected libraries return the game to full-screen mode and allow playing of the game to continue. In this way, use of the full-screen mode can be ensured.

It is important to understand that any of the embodiments described herein may be implemented as computer-readable instructions stored on a tangible computer-readable medium. Upon execution by a processor, the computer-readable instructions can cause a computing device to perform operations to implement any of the embodiments described herein.

The foregoing description of exemplary embodiments has been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated. In addition, one or more flow diagrams were used herein. The use of flow diagrams is not intended to be limiting with respect to the order in which operations are performed.

What is claimed is:

1. A method comprising:
accessing, via a service insertion tool, an executable software file containing software code that upon execution carries out a software program; and
modifying, via the service insertion tool, the executable software file, wherein the modified executable software file is configured to cause the software program to:
present a visual display of the software program in a full-screen mode; and
present additional content in the visual display of the software program in response to pre-defined triggers.

2. The method of claim 1, wherein the software program is a Flash-based software program.

3. The method of claim 1, wherein the executable software file is a shockwave flash (SWF) file.

4. The method of claim 1, wherein the modified executable software file is further configured to cause the software program to:
load injected libraries; and
present the visual display in the full-screen mode based on the injected libraries.

5. The method of claim 1, wherein the modified executable software file is further configured to cause the software program to:
present a dialog box that requests a user to provide an input to cause the software program to enter the full-screen mode; and
receive the input to cause the software program to enter the full-screen mode.

6. The method of claim 1, wherein the modified executable software file is further configured to cause the software program to determine scaling and positioning methods used by the software program.

7. The method of claim 6, wherein the modified executable software file is further configured to cause the software program to present the additional content in the visual display based on the determined scaling and positioning methods used by the software program.

8. The method of claim 1, wherein the modified executable software file is further configured to cause the software program to, upon receiving an input to exit the full-screen mode, discontinue play of the software program and present a dialog box that requests a user to provide an input to cause the software program to re-enter the full-screen mode.

9. The method of claim 1, wherein the additional content is an advertisement.

10. A service insertion tool comprising:
a viewer configured to present a software program in a user interface and receive inputs via the user interface; and
a processor configured to modify an executable software file of the software program, wherein the modified executable software file is configured to cause the software program to:
present a visual display of the software program in a full-screen mode; and
present additional content in the visual display of the software program in response to pre-defined triggers.

11. The service insertion tool of claim 10, wherein the software program is a Flash-based software program.

12. The service insertion tool of claim 10, wherein the executable software file is a shockwave flash (SWF) file.

13. The service insertion tool of claim 10, wherein the modified executable software file is further configured to cause the software program to:
load injected libraries; and
present the visual display in the full-screen mode based on the injected libraries.

14. The service insertion tool of claim 10, wherein the modified executable software file is further configured to cause the software program to:
present a dialog box that requests a user to provide an input to cause the software program to enter the full-screen mode; and
receive the input to cause the software program to enter the full-screen mode.

15. The service insertion tool of claim 10, wherein the modified executable software file is further configured to cause the software program to determine scaling and positioning methods used by the software program.

16. The service insertion tool of claim 15, wherein the modified executable software file is further configured to cause the software program to present the additional content in the visual display based on the determined scaling and positioning methods used by the software program.

17. The service insertion tool of claim 10, wherein the modified executable software file is further configured to cause the software program to, upon receiving an input to exit the full-screen mode, discontinue play of the software program and present a dialog box that requests a user to provide an input to cause the software program to re-enter the full-screen mode.

18. The service insertion tool of claim 10, wherein the additional content is an advertisement.

19. A tangible computer-readable medium having stored thereon, computer-executable instructions that, if executed by a computing device, cause the computing device to perform a method comprising:
accessing an executable software file containing software code that upon execution carries out a software program; and
modifying the executable software file, wherein the modified executable software file is configured to cause the software program to:
present a visual display of the software program in a full-screen mode; and
present additional content in the visual display of the software program in response to pre-defined triggers.

20. The tangible computer-readable medium of claim 19, wherein the software program is a Flash-based software program.

21. The tangible computer-readable medium of claim 19, wherein the executable software file is a shockwave flash (SWF) file.

22. The tangible computer-readable medium of claim 19, wherein the modified executable software file is further configured to cause the software program to:
load injected libraries; and
present the visual display in the full-screen mode based on the injected libraries.

23. The tangible computer-readable medium of claim 19, wherein the modified executable software file is further configured to cause the software program to:
present a dialog box that requests an input to cause the software program to enter the full-screen mode; and
receive the input to cause the software program to enter the full-screen mode.

24. The tangible computer-readable medium of claim 19, wherein the modified executable software file is further configured to cause the software program to determine scaling and positioning methods used by the software program.

25. The tangible computer-readable medium of claim 24, wherein the modified executable software file is further configured to cause the software program to present the additional content in the visual display based on the determined scaling and positioning methods used by the software program.

26. The tangible computer-readable medium of claim 19, wherein the modified executable software file is further configured to cause the software program to, upon receiving an input to exit the full-screen mode, discontinue play of the software program and present a dialog box that requests an input to cause the software program to re-enter the full-screen mode.

27. A method comprising:
modifying a Flash-based software program using a service insertion tool, wherein the modified Flash-based software program is configured to:
present a visual depiction of the Flash-based software program on a distraction-free display; and
present advertisements in the visual depiction of the Flash-based software program in the distraction-free display.

28. The method of claim 27, wherein the distraction-free display is a display on which a full-screen mode of the visual depiction of the Flash-based software program is presented such that the visual depiction of the Flash-based software program covers an entire display screen.
